(19) United States
(12) Patent Application Publication
(10) Pub. No.: US 2007/0177381 A1
(43) Pub. Date: Aug. 2, 2007

(54) Adjustable lighting apparatus

(76) Inventor: Frank J. Kwiatt III, Plainfield, IL (US)

Correspondence Address: HARSHAW RESEARCH, INC., 210 W. TECUMSEH STREET, OTTAWA, KS, 66067, US

(21) Appl. No.: 11/341,286

(22) Filed: Jan. 27, 2006

(51) Int. Cl. F21S 13/14

(52) U.S. Cl. 362/252

(57) ABSTRACT

An adjustable lighting apparatus includes a plurality of flexible light segments having first and second ends. Each first end includes an input connector and each second end includes an output connector such that multiple light segments may be electrically connected end to end to conformably surround objects of various diameters, such as tables. Each light segment may include light sources connected to respective input and output connectors with wiring. The wiring includes multiple conductors and is connected to a controller for selectively providing predetermined light functions, such as flashing, chasing, or deactivation after a predetermined time. Activation may be triggered by environmental sensors, such as light, motion, vibration, noise, or other like sensors.

### BACKGROUND OF THE INVENTION

The present invention relates generally to a lighting apparatus and, more particularly, to an adjustable lighting apparatus having multiple light segments with clips for efficient attachment about patio tables and having selective lighting functions.

Lengthy light strings are frequently used for decorating houses, trees, patio furniture, and other residential and commercial structures. However, these light strings are often too long to be used effectively to surround an outer peripheral edge of a table. In such a case, the remainder of a lengthy light string must be concealed or looped around the structure again.

Various devices have been proposed in the art for providing light strings and other lighting apparatuses. Many types of clips have also been proposed for attaching light strings to structures. Although assumably effective for their intended purposes, these devices do not provide adjustable length lighting segments that can be efficiently attached about the peripheries of tables.

Therefore, it would be desirable to have an adjustable lighting apparatus having a plurality of lighting segments that may be easily connected and disconnected to form a segment of a desired length. Further, it would be desirable to having an adjustable lighting apparatus having lighting segments that are flexible to conform to the curvature of a table. In addition, it would be desirable to have an adjustable lighting apparatus having a plurality of clips for attaching the light segments to a table. Finally, it would be desirable to have an adjustable lighting apparatus that includes multiple lighting functions that respond to activation of various sensors or input devices.

### SUMMARY OF THE INVENTION

Accordingly, an adjustable lighting apparatus according to the present invention includes a plurality of flexible light segments each having opposed first and second ends, with each first end having an input connector and each second end having a complementary output connector. Each light segment includes at least one light source electrically connected to the input and output connectors. One end of each segment includes a rotatable locking mechanism configured to selectively and removably mate with an opposed end of another segment such that respective input and output connectors are in electrical communication with the segments are locked together.

The lighting apparatus further includes a plurality of clips configured for attaching the light segments to a remote object such as a tabletop. Particularly, each clip includes attachment and receiving portions for being attached between a table ledge and a tabletop and for receiving light segments, respectively.

The lighting apparatus includes a controller in communication with the input and output connectors and the light sources for controlling the functions of the light sources. More particularly, the controller may activate the various connectors to flash selected light sources, to cause a “chasing” function, to light the light sources for a predetermined amount of time, or to respond to a triggering action such as from a motion or vibration sensor or the like. The apparatus includes an input device for user control over these functions.

Therefore, a general object of this invention is to provide an adjustable lighting apparatus having multiple short light segments for attachment to objects like tables with clips.

Another object of this invention is to provide a lighting apparatus, as aforesaid, in which the light segments are flexible to conform to the curvature of a table.

Still another object of this invention is to provide a lighting apparatus, as aforesaid, in which the light segments may be electrically connected end to end to establish a desired length.

Yet another object of this invention is to provide a lighting apparatus, as aforesaid, in which the light segments include a plurality of light sources that may be controlled to flash, chase, or deactivate after a predetermined time.

A further object of this invention is to provide a lighting apparatus, as aforesaid, in which the light sources may be activated by environmental conditions such as light, noise, vibration, motion, etc.

A still further object of this invention is to provide a lighting apparatus, as aforesaid, having a plurality of attachment clips are configured for attachment to many types of objects.

Other objects and advantages of this invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a rope light according to a preferred embodiment of the present invention attached to a circular table;

FIG. 2a is a perspective view of two rope light segments removed from the table and positioned for releasable attachment to one another;

FIG. 2b is an isolated view on an enlarged scale of a portion of the two rope light segments as in FIG. 2a;

FIG. 3a is another perspective view of a rope light attached about a circular table as in FIG. 1;

FIG. 3b is an isolated view on an enlarged scale of a portion of the rope light segments and table as in FIG. 3a;

FIG. 4a is a perspective view of the rope light as in FIG. 3a with the table surface and outer material of the light segments removed;

FIG. 4b is an isolated view of a portion of adjacent light segments as in FIG. 4a;

FIG. 4c is an isolated view of another portion of the light segments as in FIG. 4a showing a mounting clip;

FIG. 5 is a flowchart illustrating the function of a controller according to the present invention; and

FIG. 6 is a block diagram of the electronic components of the present invention.

### DESCRIPTION OF THE PREFERRED EMBODIMENT

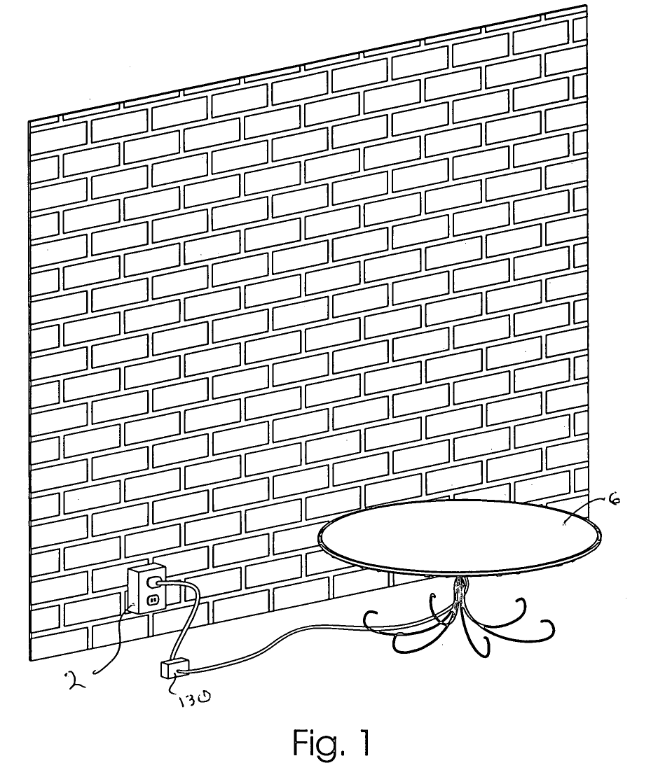

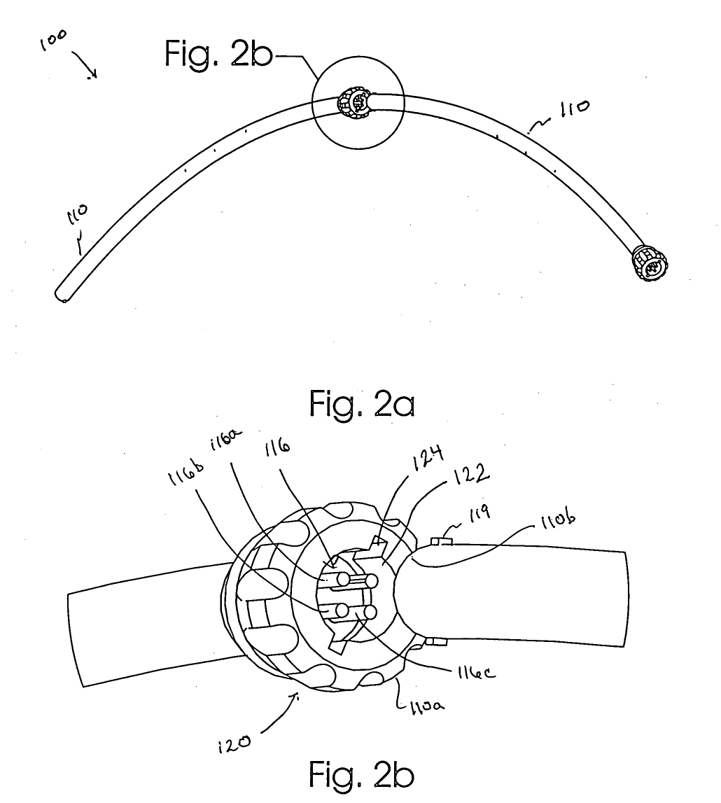

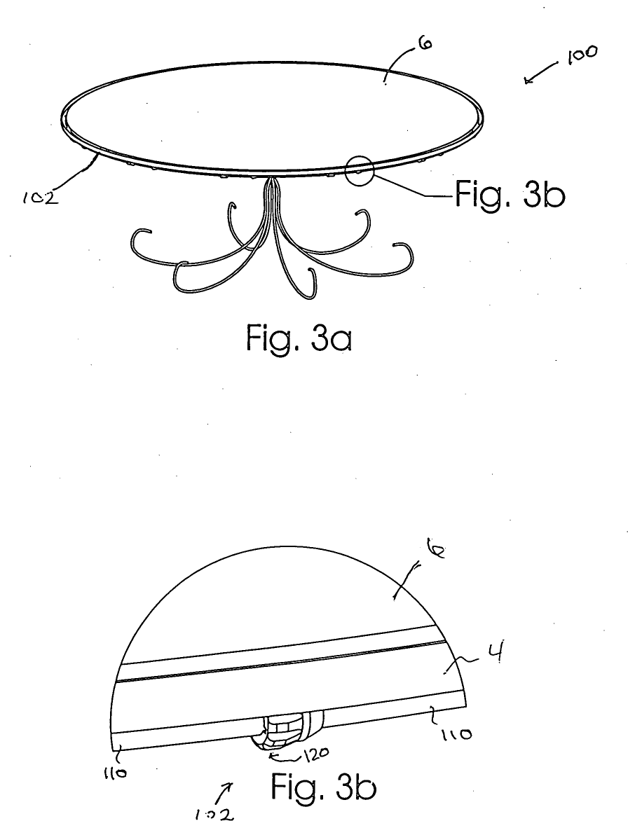

An adjustable lighting apparatus 100 according to the present invention will now be described in detail with reference to FIGS. 1 through 6 of the accompanying drawings. More particularly, an adjustable lighting apparatus 100 according to the current invention includes a plurality of flexible light segments 110 having first and second ends 110a, 110b (FIGS. 2a and 2b). Each segment includes a tubular material having a flexible outer material which holds and protects light sources and wiring, as will be described more fully below.

Each first end 110a has as input connector 112, and each second end 110b has an output connector (not shown). The input 112 and output connectors are complementary so that first ends 110a of various segments 110 may be connected to second ends 110b of various segments 110 and the respective input and output connectors will mate. The input and output connectors may be male and female connectors or another type of lead conductors. Wiring connects the input and output connectors for each segment 110, and at least some of the segments 110 have one or more light sources 118 (i.e., a LED or a light bulb) in communication with the wiring. It is understood that some segments 110 may not contain a light source 118 (i.e., these segments 110 may be used to separate segments 110 that have light sources 118, they may be used to connect segments 110 to a power source 2, etc.).

The wiring may include three or more separate conductors 116, as shown in FIG. 2b to provide additional features described below. A first conductor 116a may be a neutral conductor in communication with each light source 118 in a segment 110; a second conductor 116b may be in communication with preselected light sources 118 in the segment 110; and a third conductor 116c may be in communication with other preselected light sources 118 in the segment 110. The preselected light sources 118 and the other preselected light sources 118 may be selected by a color of the light sources 118 or a position of the light sources 118 along the segment 110. Each light source 118 in a respective segment 110 is preferably in communication with a respective neutral conductor 11 6a and another respective conductor 116, and each conductor 116 is preferably connected to a respective input connector 112 and a respective output connector.

One of the first and second ends 110a, 110b of each segment 110 may include a protrusion 119, and another of the segment's first and second ends 110a, 110b may include a rotatable locking mechanism 120 defining a channel 122 complementary to the protrusions 119. Each channel 122 has a recess 124 for housing a respective protrusion 119 when the protrusion 119 is placed in the channel 122 and the locking mechanism 120 is rotated to a closed configuration. Each locking mechanism 120 is preferably biased toward the closed configuration, such as by a spring or other known biasing element. It should be understood that the locking mechanisms 120 may alternately include the protrusions 119 and that the segments'first or second ends 110a, 110b may alternately define the complementary channel 122. When a respective protrusion 119 is in a respective recess 124 and a corresponding locking mechanism 120 is at the closed configuration, the input connectors 112 of one of the attached segments 110 are in communication with the output connectors of the other attached segment 110. This effectively places the conductors 116 of the attached segments 110 in communication with each other.

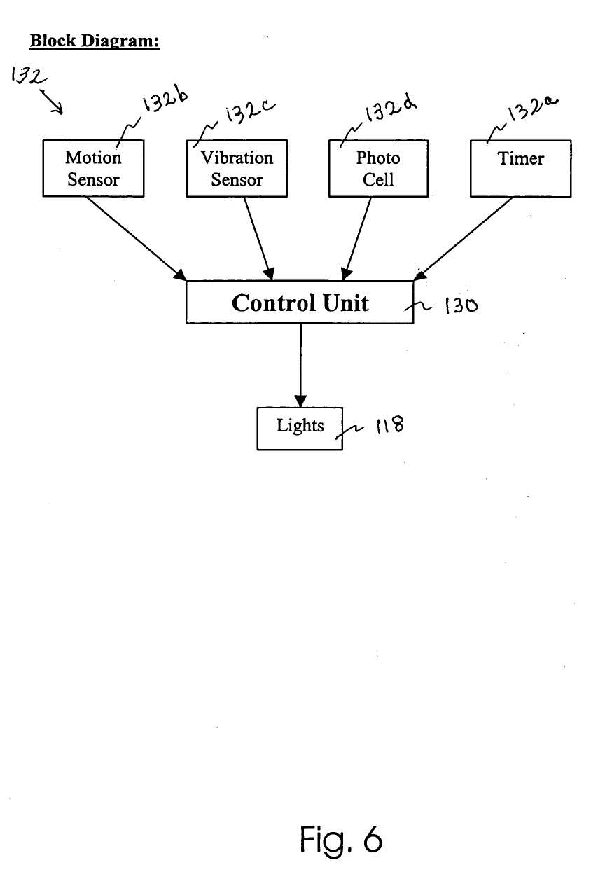

The conductors 116 are preferably in communication with the power source 2 (i.e., AC or DC power) and a controller 130 for selectively energizing the light sources 118. The controller 130 may be in communication with one or more input devices 132, and the controller 130 may include programming for energizing the light sources 118 in accordance with data received from the one or more input devices 132. Unexhaustive examples of input devices 132 include), a timer 132a, a motion sensor 132b, a vibration sensor 132c, a light sensor 132d (i.e., photocells), a switch (not shown) and an audio sensor (not shown) (FIG. 6). The programming may include programming for, among other things, selectively energizing the light sources 118 in a blinking manner, a successive (“chasing”) manner, or by the color of the light sources 118. Further, the programming may synchronize the energizing of the light sources 118 to audible sounds detected by the audio sensor.

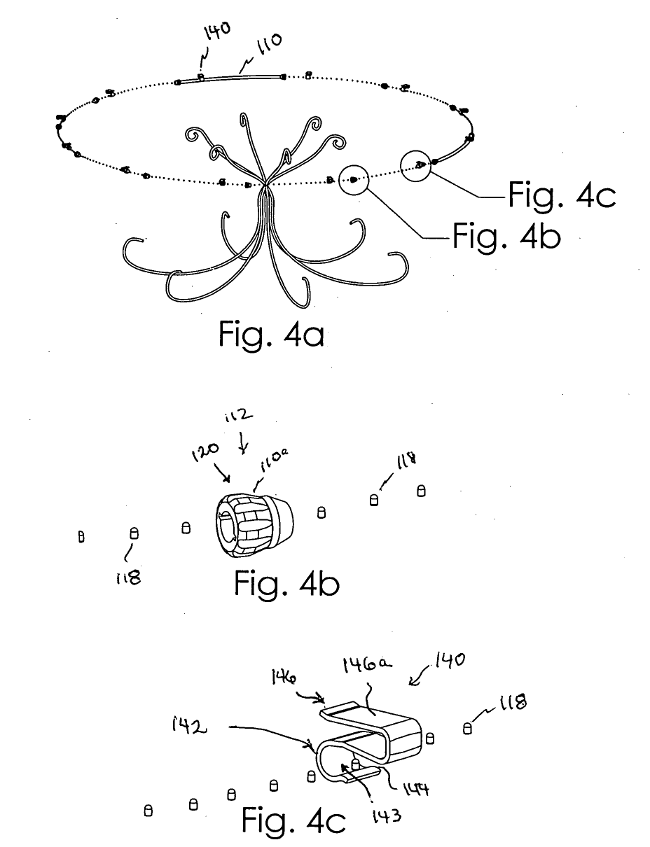

A plurality of clips 140 may selectively attach the segments 110 to a remote object. A representative clip 140 is shown in FIG. 4c. Each clip 140 may include a receiving portion 142 defining a receiving area 143 for selective attachment to the segments 110. Each receiving area 143 has a diameter larger than an outer diameter of the segments 110 so that a respective segment 110 may be received in the receiving area 143. Each receiving portion 142 has a configuration such that more than one hundred and eighty degrees about a respective segment 110 may be selectively received in the receiving area 143, as shown in FIG. 4c. Each receiving portion 142 is preferably at least partially constructed of a resilient material that is biased so that the receiving portion 142 is at a closed configuration. An end 144 of each receiving portion 142 may be flared to allow a user to easily move the receiving portion 142 from the closed configuration to an open configuration.

Each clip 140 may further include an attachment portion 146 for placement between a table ledge 4 and a tabletop 6 that is receivable in the ledge. A top portion 146a of each attachment portion 146 may include a material that will not damage the tabletop 6 (i.e., rubber, felt, etc.). The attachment portion 146 and the receiving portion 142 of each clip 140 may also be selectively separable to allow an item to be selectively located between the attachment and receiving portions 146, 142.

In use, two segments 110 may be selected, and a first end 110a of one of the selected segments 110 may be placed adjacent a second end 110b of the other selected segment 110 as shown in FIGS. 2a and 2b. The locking mechanism 120 may then be rotated to an open configuration, the input 112 and output connectors may be placed together, and the protrusion 119 may enter the channel 122. The locking mechanism 120 may then return to the closed configuration, securing the two segments 110 together. This may be done repeatedly to construct an assembled strand 102 having a desired length. The segments 110 preferably each have a length that is not greater than one foot long so that an overall length of an assembled strand 102 may be precisely selected.

The power source 2 and the controller 130 may then be placed in communication with a free input connector 112 of the assembled strand 102, and the assembled strand 102 may be attached to an object. For example, the attachment portion 146 of clips 140 may be placed between a table ledge 4 and a tabletop 6. The top portions of the clips 140 do not scratch or damage the tabletop 6 due to the material used for the top portions. The user may move the receiving portions to the open configurations by using the flared ends, the segments 110 may be placed in the clips' receiving portions, and the user may allow the receiving portions to return to the closed configurations, whereby attaching the assembled strand 102 to the clips 140.

For another example, the user may separate the receiving portions 142 and the attachment portions 146 of the clips 140, place an item therebetween, and then allow the receiving and attachment portions 142, 146 to move closer together. The segments 110 may be attached to the clips 140 as described above, resulting in the assembled strand 102 being attached to the item located between the receiving and attachment portions 142, 146.

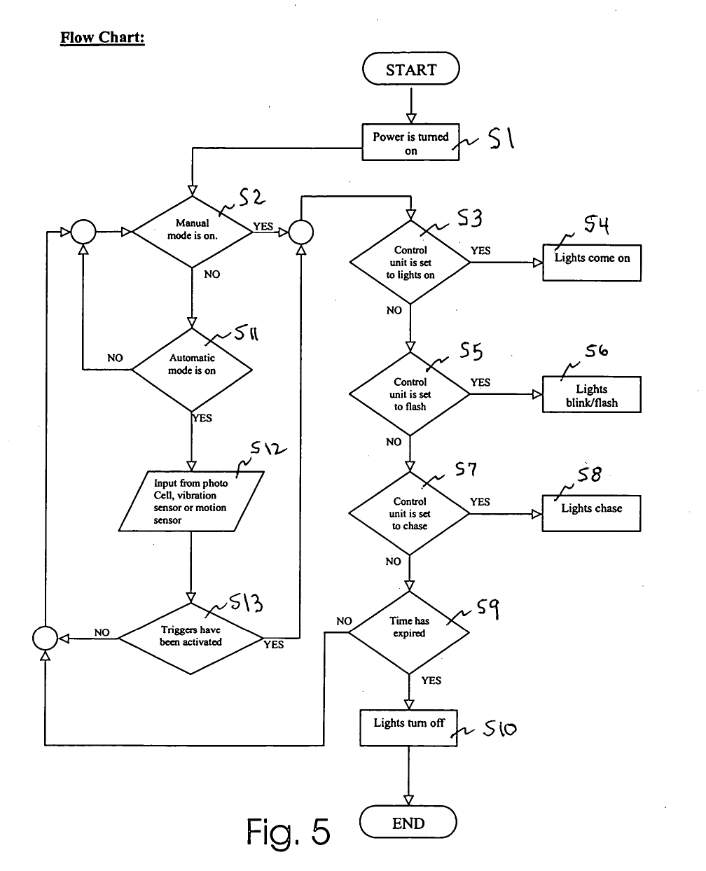

An exemplary process used by the controller 130 is shown in FIG. 5. At step S1, the assembled strand 102 is placed in communication with the power source 2 and the controller 130 as described above. The process then proceeds to step S2. At step S2, the controller 130 determines whether the user has selected a manual mode of operation through an input device 132. If so, the process continues to step S3; if not, the process proceeds to step S11.

At step S3, the controller 130 determines whether the user has chosen to turn the light sources 118 “on” by using an input device 132 such as a switch. If so, the controller 130 continues to step S4, where the controller 130 actuates the light sources 118. If not, the controller 130 proceeds to step S5.

At step S5, the controller 130 determines whether the user has chosen to turn the light sources 118 to “flash” by using the input device 132. If so, the controller 130 continues to step S6, where the controller 130 causes the light sources 118 to blink. If not, the controller 130 proceeds to step S7.

At step S7, the controller 130 determines whether the user has chosen to turn the light sources 118 to “chase” by using the input device 132. If so, the controller 130 continues to step S8, where the controller 130 causes the light sources 118 to actuate in a successive (“chasing”) manner. If not, the controller 130 proceeds to step S9.

At step S9, the controller 130 determines whether the user has selected a predetermined amount of time for the light sources 118 to remain actuated. If so, the process returns to step S2. If not, the process proceeds to step S10, where the light sources 118 are turned “off” and the process is ended.

At step S11, the controller 130 determines whether the user has selected an automatic mode of operation through an input device 132. If so, the process continues to step S12; if not, the process returns to step S2.

At step S12, the controller 130 receives input from the input device 132; the process then continues to step S13.

At step S13, the controller 130 determines whether the input device 132 has detected a triggering event (i.e., for the motion sensor 132c, the triggering event would be sensing motion, etc.). If so, the process proceeds to step S3; if not, the process returns to step S2.

Accordingly, it can be seen that the present invention enables a user to provide custom lighting systems to furniture such as patio tables or the like in a superior manner over traditional lighting options. Specifically, rope light strings may be configured to exactly fit a particular table diameter, to be held securely thereabout, and to be configured to provide many light features based on environmental conditions.

It is understood that while certain forms of this invention have been illustrated and described, it is not limited thereto except insofar as such limitations are included in the following claims and allowable functional equivalents thereof.

What is claimed is as follows:

1. An adjustable lighting apparatus, comprising:
a plurality of flexible light segments having first and second ends, each first end having an input connector and each second end having an output connector complementary to said respective input connectors, wiring connecting said input and output connectors for each respective segment, at least some of said segments having one or more light source in communication with said wiring; and
a plurality of clips for selectively attaching said segments to a remote object.

2. The apparatus as in claim 1, wherein:
each said clip includes a receiving portion defining a receiving area for selective attachment to said segments;
each said receiving area has a diameter larger than an outer diameter of said segments, whereby a respective segment may be received in said receiving area; and
each said receiving portion has a configuration such that more than one hundred and eighty degrees about a respective segment may be selectively received in said receiving area, each said receiving portion being at least partially constructed of a resilient material being biased so that said receiving portion is at a closed configuration.

3. The apparatus as in claim 2, wherein an end of each receiving portion is flared to allow a user to easily move the receiving portion to an open configuration.

4. The apparatus as in claim 2 for use with a table having a ledge and a tabletop receivable in the ledge, wherein each said clip includes an attachment portion for placement between the table ledge and the tabletop, each attachment portion having a top side that includes a material that will not damage the tabletop.

5. The apparatus as in claim 4, wherein said attachment portion and said receiving portion of each said clip are selectively separable to allow an item to be selectively located between said attachment and receiving portions.

6. The apparatus as in claim 1, wherein:
one of said first and second ends of each said segment includes a protrusion; and
another of said first and second ends of each said segment includes a rotatable locking mechanism defining a channel complementary to said respective protrusions, each said channel having a recess for housing a respective protrusion when said protrusion is placed in said channel and said locking mechanism is rotated to a closed configuration.

7. The apparatus as in claim 6, wherein each said locking mechanism is biased toward said closed configuration.

8. The apparatus as in claim 1, wherein said segments each have a length that is not greater than one foot long.

9. The apparatus as in claim 1, wherein:
said wiring in each respective segment includes three or more separate conductors, a first conductor being a neutral conductor and being in communication with each said light source in said segment, a second conductor being in communication with preselected light sources in said segment, a third conductor being in communication with other preselected light sources in said segment;
each said light source in a respective segment is in communication with said neutral conductor and another said conductor; and
each said conductor is connected to a respective input connector and a respective output connector.

10. The apparatus as in claim 9, wherein said preselected light sources and said other preselected light sources are selected by a color of said light sources or a position of said light sources.

11. The apparatus as in claim 10, wherein said conductors are in communication with a power source and a controller for selectively energizing said light sources.

12. The apparatus as in claim 11, wherein:
said controller is in communication with an input device; and
said controller includes programming for energizing said light sources in accordance with data received from said input device.

13. The apparatus as in claim 12, wherein said input device is selected from the group consisting of a timer, a motion sensor, a vibration sensor, a light sensor, an audio sensor, and a switch.

14. The apparatus as in claim 11, wherein said controller includes programming for selectively energizing said light sources in a blinking manner, a successive manner, or by a color of said light sources.

15. The apparatus as in claim 1, wherein:
one of said input connectors and said output connectors are male connectors; and
another of said input connectors and said output connectors are female connectors.

16. The apparatus as in claim 1, wherein:
each said clip includes a receiving portion defining a receiving area for selective attachment to said segments;
each said receiving area has a diameter larger than an outer diameter of said segments, whereby a respective segment may be received in said receiving area;
each said receiving portion has a configuration such that more than one hundred and eighty degrees about a respective segment may be selectively received in said receiving area, each said receiving portion being at least partially constructed of a resilient material being biased so that said receiving portion is at a closed configuration;
one of said first and second ends of each said segment includes one of a protrusion and a channel;
another of said first and second ends of each said segment includes a rotatable locking mechanism defining another of a protrusion and a channel, said protrusion and said channel being complementary, each said channel having a recess for housing a respective protrusion when said protrusion is placed in said channel and said locking mechanism is rotated to a closed configuration;
said wiring in each respective segment includes three or more separate conductors, a first conductor being a neutral conductor and being in communication with each said light source in said segment, a second conductor being in communication with preselected light sources in said segment, a third conductor being in communication with other preselected light sources in said segment;
each said light source in a respective segment is in communication with said neutral conductor and another said conductor; and
each said conductor is connected to a respective input connector and a respective output connector.

17. The apparatus as in claim 16 for use with a table having a ledge and a tabletop receivable in the ledge, wherein:
each said clip includes an attachment portion for placement between the table ledge and the tabletop, each attachment portion having a top side that includes a material that will not damage the tabletop;
each said locking mechanism is biased toward said closed configuration; and
said preselected light sources and said other preselected light sources are selected by a color of said light sources or a position of said light sources.

18. The apparatus as in claim 17, wherein said light sources are LEDs.

19. An adjustable lighting apparatus, comprising:
a plurality of flexible light segments having first and second ends, each first end being releasably attachable to each second end; and
a plurality of clips for selectively attaching said segments to a remote object, each said clip including a receiving portion defining a receiving area for selective attachment to said segments, each said receiving area having a diameter larger than an outer diameter of said segments, whereby a respective segment may be received in said receiving area, each said receiving portion having a configuration such that more than one hundred and eighty degrees about a respective segment may be selectively received in said receiving area, each said receiving portion being at least partially constructed of a resilient material being biased so that said receiving portion is at a closed configuration.

20. An adjustable lighting apparatus, comprising a plurality of flexible light segments having first and second ends and a plurality of light sources therebetween, each first end having a plurality of input connectors and each second end having a plurality of output connectors complementary to said respective input connectors, each of a plurality of separate conductors being in communication with a respective input connector, a respective output connector, and respective preselected light sources so that each light source is in communication with a neutral conductor and another said conductor.
